(19) United States
(12) Patent Application Publication
(10) Pub. No.: US 2010/0294830 A1
(43) Pub. Date: Nov. 25, 2010

(54) FOLDER

(76) Inventor: James C. HUANG, Taichung City (TW)

Correspondence Address: EGBERT LAW OFFICES, 412 MAIN STREET, 7TH FLOOR, HOUSTON, TX, 77002, US

(21) Appl. No.: 12/469,613

(22) Filed: May 20, 2009

(51) Int. Cl. B42F 7/14

(52) U.S. Cl. 229/101

(57) ABSTRACT

The present invention provides a folder, including at least a folder body, at least a first partition board with a clamp, and a locator. The folder body is provided with a front panel, rear panel, bottom plate, side plate, inner space and locator. The first partition board with clamp is arranged within the inner space to divide the inner space into at least two spaces and arranged at intervals to define an accommodating interlayer. The accommodating interlayer is provided with a limiting portion with an access opening. The bottom of the accommodating interlayer is closed. The bottom of the inner space of the folder body is positioned via a locator. The first partition board along with the clamp can be used for reclaiming and separation, thus realizing multi-functional applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a folder, and more particularly to an innovative folder with at least one partition board to be fitted with a clamp, allowing for both reclaiming and partitioning.

2. Description of Related Art Including Information Disclosed Under 37 CFR 1.97 and 37 CFR 1.98

There are a variety of folder products in the stationery market, which are used to accommodate documents and papers in an orderly manner. An expandable folder, currently available, is provided with a plurality of spacers, between which a space is formed for accommodating the documents.

However, the aforementioned folders shall be further improved with respect to structure because the interior is of great concern. This is because that the typical structure has shortcomings, such as difficulty in accommodating properly different documents, data or office supplies. Hence, industrial operators must make continuous efforts to resolve the technical problems and realize their objectives for meeting customer requirements.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based on the unique present invention, the folder has a first partition board to be fitted with a clamp at intervals so as to define an accommodating interlayer. The clamp of the present invention can be directly linked to the first partition board, so that the first partition board along with the clamp can be used for reclaiming and separation, so as to properly store different documents, data or office supplies with improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the preferred embodiment of the present invention.

FIG. 2 shows a sectional view of the preferred embodiment of the present invention.

FIG. 3 shows a top plan view of the preferred embodiment of the present invention.

FIG. 4 shows a partially enlarged sectional view of the limiting portion of the present invention.

FIG. 5 shows a partial top plan view and partial sectional view of the accommodating interlayer of the present invention.

FIG. 6 shows a sectional view of the second preferred embodiment of the accommodating interlayer of the present invention.

FIG. 7 shows a sectional view of the third preferred embodiment of the accommodating interlayer of the present invention.

FIG. 8 shows a top plan view of another preferred embodiment of the present invention.

### DETAILED DESCRIPTION OF THE INVENTION

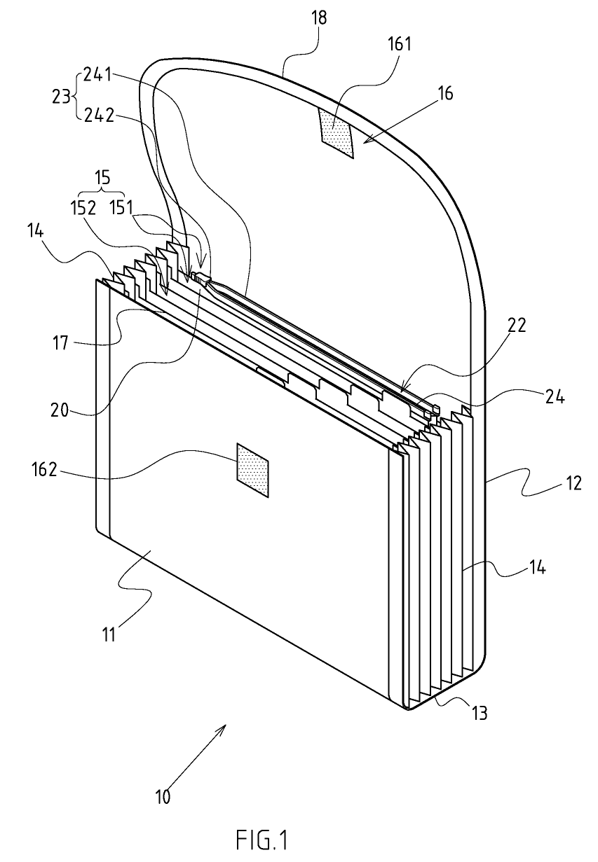

FIGS. 1-3 depict preferred embodiments of a folder of the present invention. The embodiments are provided for only explanatory purposes with respect to the patent claims.

The folder comprises a folder body 10, which is provided at intervals with a front panel 11, a rear panel 12, a bottom plate 13, two V-shaped corrugated side plates 14 as well as an inner space 15 arranged between the front and rear panels 11, 12. Since the side plate 14 is of V-shaped corrugated surface, the folder will be compressed when accommodating thin-profile documents.

At least one first partition board 20 with a clamp 21 is arranged into the inner space 15 of the folder body 10 and used to separate the inner space 15 into at least two spaces 151. Moreover, two corresponding ends of both the first partition board 20 and the side plate 14 of the folder body 10 are superimposed (e.g. by means of heat pressing). The first partition board 20 and the bottom plate 13 are spaced, of which the first partition board 20 and the clamp 21 are arranged at intervals to define an accommodating interlayer 22. The accommodating interlayer 22 is provided with a limiting portion 23 with an access opening 24. The bottom of the accommodating interlayer 22 is closed so that the first partition board 20 along with the clamp 21 can be used for reclaiming and separation.

A locator 16 is used to position the top of the inner space 15 of the folder body 10.

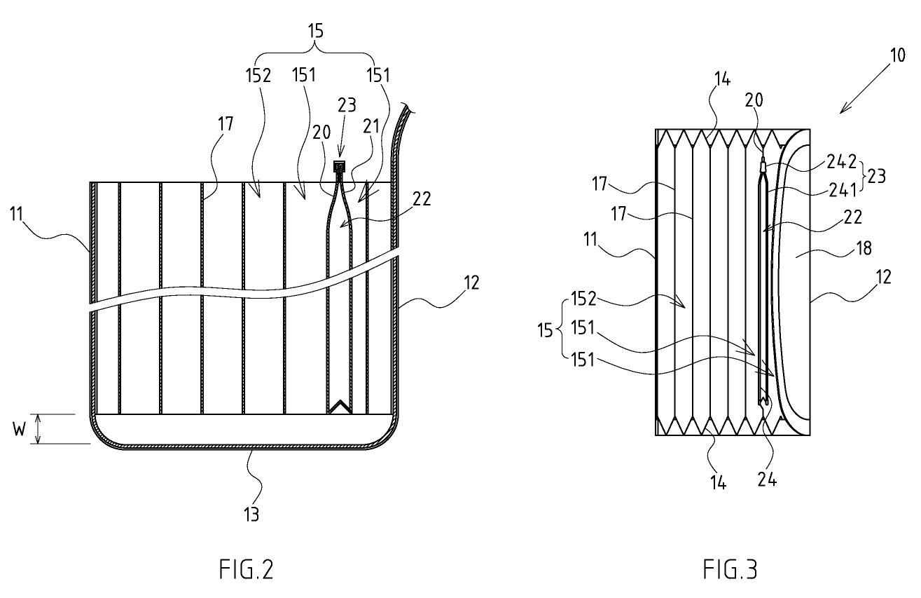

The folder contains at least a second partition board 17 (shown in FIG. 1), which is arranged within the inner space 15 of the folder body 10 and spaced with the first partition board 20 with a clamp 21, thus forming a space 151. When a plurality of second partition boards 17 are arranged at intervals, another space 152 is formed between them. Moreover, two corresponding ends of both the second partition board 17 and the side plate 14 of the folder body 10 are superimposed (e.g. by means of heat pressing). The second partition board 17 and the bottom plate 13 are spaced (shown by W in FIG. 2), while the space 151 and the other space 152 are used to accommodate the documents.

The limiting portion 23 is composed of a gripping chain 241 and a gripping head 242 assembled onto the access opening 24, so that the gripping head 242 slide transversely on the gripping chain 241, allowing to turn-on/-off the access opening 24 of the accommodating interlayer 22.

The limiting portion 23 is available with either of the following patterns: linking tape, male and female buckles, and cover.

The locator 16 is transversely arranged on the tie strap of the front and rear panels 11, 12, while the top of the inner space 15 of the folder body 10 is tightened. Alternatively, referring to FIG. 1, a cover plate 18 is extended from the top of the rear panel 12 of the folder body 10. The locator 16 is arranged on the male linking tape 161 on the cover plate 18 and correspondingly on the female linking tape 162 of the front panel 11. Then, the cover plate 18 is folded downwards, and the male linking tape 161 is mated with the female linking tape 162, so that the cover plate 18 can cover the top of the inner space 15 to prevent the documents from falling out of the spaces 151, 152.

Based upon above-specified structure, the present invention is operated as follows:

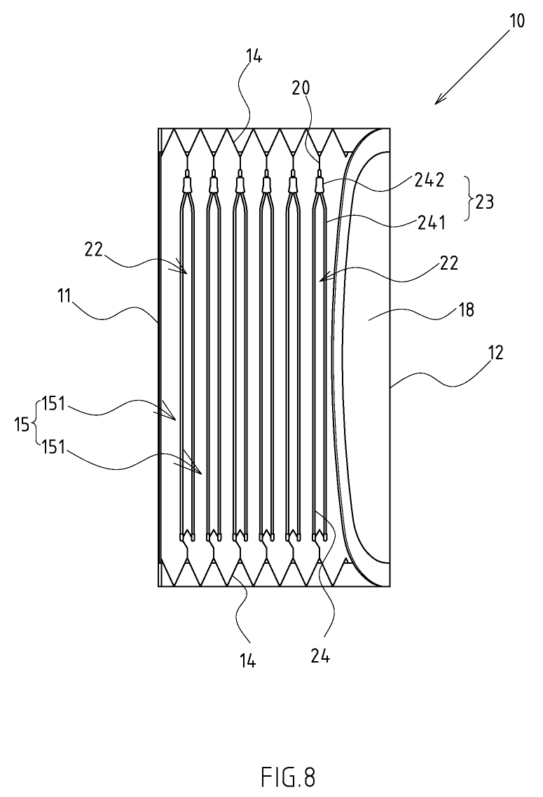

Referring to FIG. 1, the folder is provided with a plurality of second partition boards 17 and a first partition board 20 with a clamp 21. When the folder is used for reclaiming purposes, the locator 16 is first released, and then different documents, data or office supplies are reclaimed into the spaces 151, 152 in an orderly manner. After completion of reclaiming, the locator 16 is then positioned together with the folder body 10, such that the documents are reclaimed into the expandable folder; or referring to FIG. 8, the folder of the preferred embodiment permits the first partition board 20 with a clamp 21 to form a plurality of spaces 151, thereby meeting the diversified customer requirements with ease-of-operation.

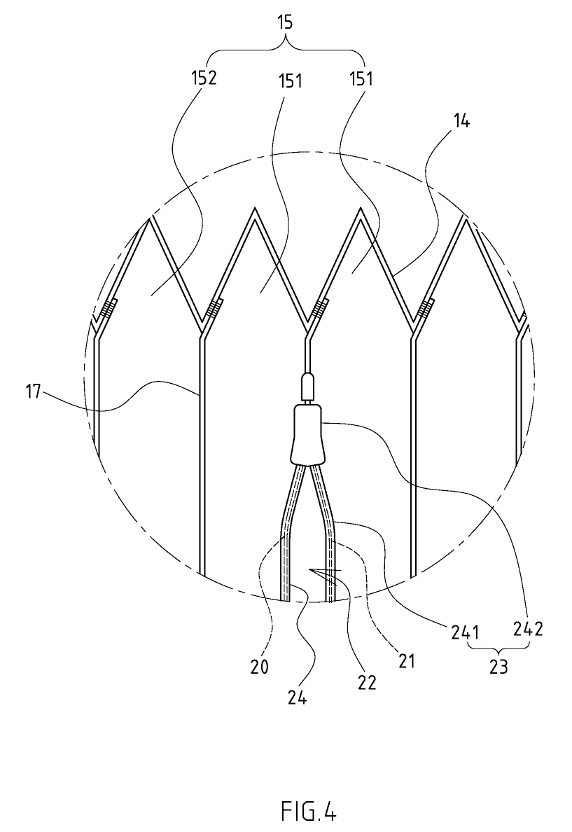

Referring also to FIG. 4 (in conjunction with FIG. 2), based on the clamp 21 and the first partition board 20 being arranged at intervals to form the accommodating interlayer 22, the small-sized or specific documents, data or office supplies can be further reclaimed through the accommodating interlayer 22. As the gripping head 242 of the limiting portion 23 slides transversely in the gripping chain 241, the access opening 24 of the accommodating interlayer 22 is closed, enabling the documents in the accommodating interlayer 22 to be positioned securely.

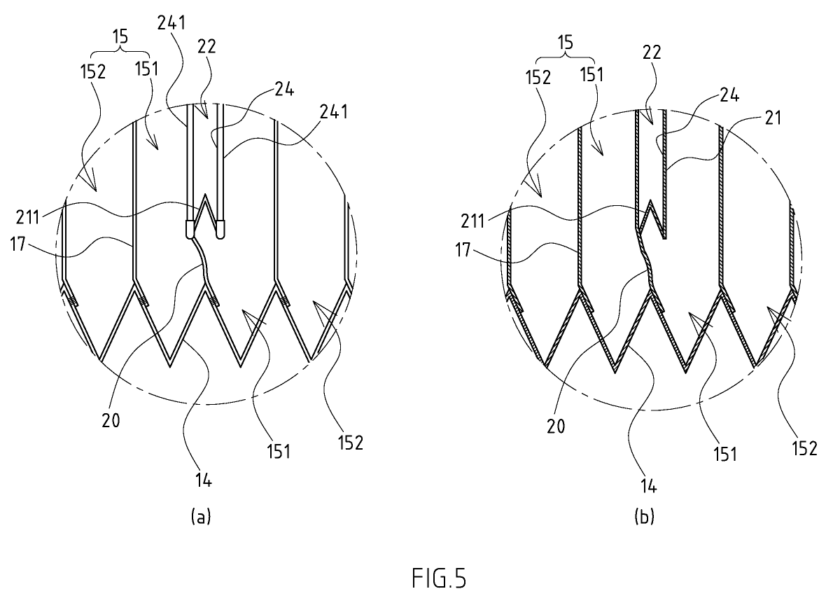

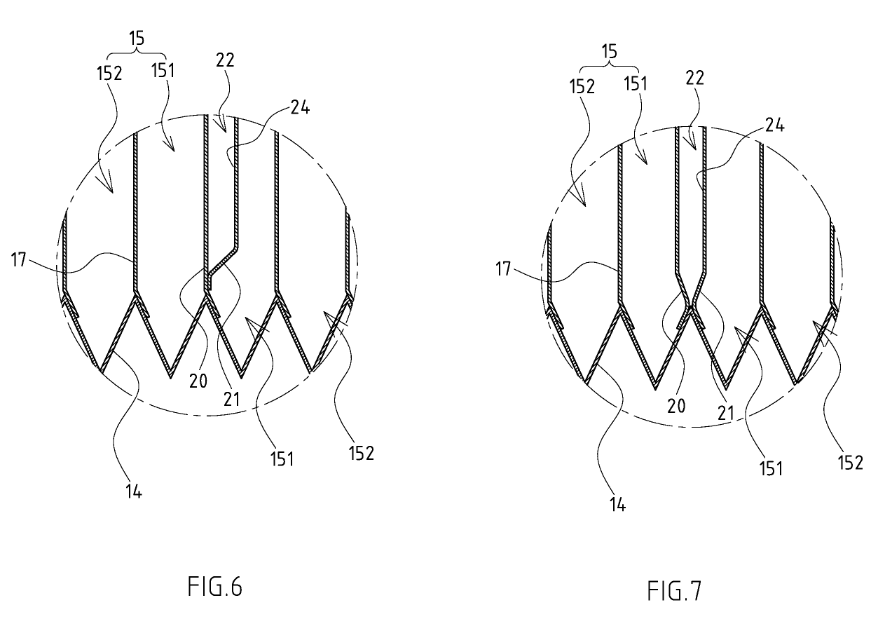

FIGS. 5, 6 and 7 depict applications of different structural patterns of the accommodating interlayer 22 of the present invention. Referring to FIG. 5 (a), (b), a folding flange 211 is formed at one end of the clamp 21 of the accommodating interlayer 22 and linked to the first partition board 20. Referring also to FIG. 6, the clamp 21 is directly coupled with the first partition board 20 and fixed by means of heat pressing. Referring also to FIG. 7, the first partition board 20 and the clamp 21 is separately linked onto the peak of the V-shaped corrugated surface of the side plate 14, such that the first partition board 20 and the clamp 21 can also be mated securely.

1. A folder, comprising:
a folder body, being comprised of a front panel, a rear panel, a bottom plate, two V-shaped corrugated side plates and an inner space arranged between the front and rear panels;
a first partition board with a clamp, being arranged into an inner space of the folder body, and dividing said inner space into at least two spaces, said first partition board and the side plate of the folder body being mated, said first partition board and the bottom plate being spaced, said first partition board and the clamp being arranged at intervals to define an accommodating interlayer, said accommodating interlayer being provided with a limiting portion with an access opening and having a bottom closed so that the first partition board along with the clamp can be used for reclaiming and separation;
a locator, positioning a top of the inner space of the folder body.

2. The folder defined in claim 1, further comprising:
a second partition board, being spaced with the first partition board with a clamp, said second partition board and the side plate of the folder body being mated, and said second partition board and the bottom plate being spaced.

3. The folder defined in claim 1, wherein the limiting portion is comprised of a gripping chain and a gripping head assembled onto the access opening, allowing to turn-on/-off the accommodating interlayer.

4. The folder defined in claim 1, wherein the limiting portion is available with either of the following patterns: linking tape, male and female buckles, and cover.

5. The folder defined in claim 1, further comprising:
a cover plate extended from the top of the rear panel of the folder body, said locator being arranged on the male linking tape on the cover plate and corresponding to the female linking tape of the front panel for mating purpose.
